(19) United States
(12) Patent Application Publication
(10) Pub. No.: US 2018/0248238 A1
(43) Pub. Date: Aug. 30, 2018

(54) GRAPHENE ENHANCED COOLING FIN

(71) Applicant: James O. Pinon, Troy, MI (US)

(72) Inventor: James O. Pinon, Troy, MI (US)

(21) Appl. No.: 15/904,074

(22) Filed: Feb. 23, 2018

Related U.S. Application Data
(63) Continuation-in-part of application No. 15/856,127, filed on Dec. 28, 2017.
Application No. 15/856,127 is a continuation-in-part of application No. 14/853,936, filed on Sep. 14, 2015.
(60) Provisional application No. 62/462,504, filed on Feb. 23, 2017.
(60) Provisional application No. 62/583,831, filed on Nov. 9, 2017.
(60) Provisional application No. 62/439,643, filed on Dec. 28, 2016.
(60) Provisional application No. 62/050,670, filed on Sep. 15, 2014.

(51) Int. Cl. H01M 10/6556; H01M 10/613; H01M 10/647; H01M 10/653; H01M 10/6551; H01M 10/6555

(52) U.S. Cl. CPC H01M 10/6556; H01M 10/613; H01M 10/647; H01M 10/625; H01M 10/6551; H01M 10/6555; H01M 10/653

(57) ABSTRACT

An apparatus for cooling a multi-cell energy storage device includes a multi-layered graphene enhanced cooling fin. The cooling fin includes a first layer including a structurally rigid material layer configured to provide physical strength to the graphene enhanced cooling fin, a second layer including a graphene material layer coating a portion of a first side of the structurally rigid material layer, and a third layer. The third layer can be one of a second structurally rigid material layer covering the graphene material layer or a second graphene material layer coating a portion of a second side of the structurally rigid material layer.

### CROSS REFERENCE TO RELATED APPLICATION

This disclosure claims the benefit of U.S. Provisional Application No. 62/462,504 filed on Feb. 23, 2017 and of U.S. Provisional Application No. 62/583,831 filed on Nov. 9, 2017 and is a continuation in part application of U.S. patent application Ser. No. 15/856,127 filed on Dec. 28, 2017 which claims the benefit of U.S. Provisional Application No. 62/439,643 filed on Dec. 28, 2016 and which is a continuation in part application of U.S. patent application Ser. No. 14/853,936 filed on Sep. 14, 2015 which claims the benefit of U.S. Provisional Application No. 62/050,670 filed on Sep. 15, 2014, all of which are hereby incorporated by reference.

### TECHNICAL FIELD

This disclosure is related to thermal management systems used in energy storage devices. In particular, the disclosure is related to heat management in multi-cell devices, for example, used in electrically powered or hybrid power vehicles or stationary or back-up power systems.

### BACKGROUND

The statements in this section merely provide background information related to the present disclosure. Accordingly, such statements are not intended to constitute an admission of prior art. Batteries used in vehicular-scale energy storage generate significant

Batteries used in vehicular-scale energy storage generate significant heat, for example, during charging cycles and during power generation discharge cycles. Placing fins, for example, made of steel or aluminum between battery cells is known whereby the fins act as heat sinks, drawing heat away from the battery cells and transmitting the heat away from the batteries. However, package space within battery packs is limited, and the fins generally must be thin to fit the required package size. As a result, simple fins are limited in how much heat they can manage in a battery pack including multiple battery cells.

Other cooling fin configurations are known. One configuration includes a hollow fin passing a liquid through the fin and exchanging heat from the proximate battery cells into the liquid which is then cycled out of the fin and cooled through known thermal cycles. However, such systems are inherently complex, requiring waterproof seals at every connection point; expensive, requiring a liquid pump and a connecting heat exchanger to dissipate the heat; and prone to exposing the battery cells to liquid from leaking fins and connections.

### SUMMARY

An apparatus for cooling a multi-cell energy storage device includes a multi-layered graphene enhanced cooling fin. The cooling fin includes a first layer including a structurally rigid material layer configured to provide physical strength to the graphene enhanced cooling fin, a second layer including a graphene material layer coating a portion of a first side of the structurally rigid material layer, and a third layer. The third layer can be one of a second structurally rigid material layer covering the graphene material layer or a second graphene material layer coating a portion of a second side of the structurally rigid material layer.

### BRIEF DESCRIPTION OF THE DRAWINGS

One or more embodiments will now be described, by way of example, with reference to the accompanying drawings, in which:

FIG. 1 illustrates an exemplary graphene enhanced cooling fin for use in a multi-cell battery pack from a top, front perspective view, in accordance with the present disclosure;

FIG. 2 illustrates the graphene enhanced cooling fin of FIG. 1 from a bottom, rear perspective view, in accordance with the present disclosure;

FIG. 3 illustrates an exemplary battery cell aligned for assembly with the enhanced cooling fin of FIG. 1, in accordance with the present disclosure;

FIG. 4 illustrates an exemplary cross sectional view of the enhanced cooling fin of FIG. 1, in accordance with the present disclosure;

FIG. 5 illustrates an exemplary cross sectional view of an alternative embodiment of a graphene enhanced cooling fin with a layer of graphene platelets covering one side of a flat panel portion, in accordance with the present disclosure;

FIG. 6 illustrates an exemplary cross sectional view of an alternative embodiment of a graphene enhanced cooling fin with a layer of graphene platelets covering both sides of a flat panel portion, in accordance with the present disclosure;

FIG. 7 illustrates an exemplary cross sectional view of an alternative embodiment of a graphene enhanced cooling fin with an exemplary enhanced aluminum plate surrounded around a perimeter by an enhanced plastic structural rim portion, in accordance with the present disclosure;

FIG. 8 illustrates an exemplary cross sectional view of an alternative embodiment of a graphene enhanced cooling fin with an exemplary aluminum plate surrounded entirely by an enhanced plastic structural rim portion, in accordance with the present disclosure;

FIG. 9 illustrates an exemplary cross sectional view of an alternative embodiment of a graphene enhanced cooling fin with an exemplary central plate sandwiched on either side entirely by enhanced plastic surface portions, in accordance with the present disclosure;

FIG. 10 illustrates the graphene enhanced cooling fin of FIG. 1 with a battery cell engaged thereto, with the enhanced cooling fin installed to an exemplary liquid cooled cooling plate, in accordance with the present disclosure;

FIG. 11 illustrates the graphene enhanced cooling fin of FIG. 10 separated from the cooling plate for illustration, with two battery cells positioned to be engaged to either side of the enhanced cooling fin, in accordance with the present disclosure;

FIG. 12 illustrates a plurality of enhanced cooling fins attached to the cooling plate of FIG. 10, in accordance with the present disclosure;

FIGS. 13-16 illustrate an additional embodiment of battery cell components that are made with plastic enhanced with graphene, in accordance with the present disclosure;

FIG. 13 illustrates a plastic housing enhanced with graphene configured to transfer heat away from a battery core;

FIG. 14 illustrates coolant lines that can be installed to the enhanced cooling fin of FIG. 13 in order to transfer heat away from the enhanced cooling fin;

FIG. 15 illustrates the enhanced cooling fin and coolant lines of FIG. 14, with a battery core and a cover in an expanded view, with the core in position to be placed within an indented pocket in the enhanced cooling fin; and

FIG. 16 illustrates a plurality of enhanced cooling fins with battery cores installed thereto stacked and attached to coolant lines;

FIG. 17 illustrates an exemplary central processing unit cooling fin constructed with a graphene enhanced plastic material, in accordance with the present disclosure;

FIG. 18 illustrates an additional exemplary central processing unit cooling fin constructed with a graphene enhanced plastic material and including a phase change circuit, in accordance with the present disclosure;

FIG. 19 illustrates an exemplary radiator device used in automotive applications with graphene enhanced plastic cooling structures, in accordance with the present disclosure;

FIG. 20 illustrates an exemplary pair of aluminum plates with a layer of graphene materials interposed between the plates, in accordance with the present disclosure;

FIG. 21 illustrates the aluminum plates and graphene materials of FIG. 20 encased within a molded plastic unit, in accordance with the present disclosure;

FIG. 22 illustrates the aluminum plates and graphene materials of FIG. 20 partially encased within a molded plastic unit, with heat rejection finsexposed on either side of the aluminum plates, in accordance with the present disclosure;

FIG. 23 illustrates an additional exemplary embodiment of an enhanced cooling fin including a pair of snap-fit gripping features configured to engage cooling tubes to the cooling fin, in accordance with the present disclosure;

FIG. 24 illustrates an additional exemplary embodiment of an enhanced cooling fin including a ninety degree bend for attachment to a cooling plate, in accordance with the present disclosure;

FIG. 25 illustrates a stack of a plurality of cooling fins according to the cooling fin of FIG. 24, in accordance with the present disclosure;

FIG. 26 illustrates an exemplary multi-layered cooling fin including a structurally rigid core material coated on both sides with graphene material including a ninety degree bend in the cooling fin, in accordance with the present disclosure;

FIG. 27 illustrates another exemplary multi-layered cooling fin including a structurally rigid core material coated on both sides with graphene material, in accordance with the present disclosure;

FIG. 28 illustrates an exemplary multi-layered cooling fin including a layer of graphene positioned between two structurally rigid material layers including a ninety degree bends in the structurally rigid material layers, in accordance with the present disclosure;

FIG. 29 illustrates another exemplary multi-layered cooling fin including a layer of graphene positioned between two structurally rigid material layers, in accordance with the present disclosure;

FIG. 30 illustrates another exemplary multi-layered cooling fin including a layer of graphene positioned between two structurally rigid material layers including a ninety degree bend in the cooling fin, in accordance with the present disclosure;

FIG. 31 includes an exemplary multi-layered cooling fin including including a structurally rigid core material coated on both sides with graphene material and with layers of protective material covering the graphene coatings, in accordance with the present disclosure; and

FIG. 32 illustrates a section of an exemplary multi-layered cooling fin including including a structurally rigid core material, graphene material layers, a thermally resistant layer, and with layers of protective material covering the graphene coatings, in accordance with the present disclosure.

### DETAILED DESCRIPTION

A device or apparatus including a cooling fin for use in multiple cell battery packs is disclosed, replacing traditional cooling fins and related designs used to remove heat from or transfer heat to battery cells, fuel cells, multiple cell capacitors, or similar energy storage devices.

Throughout the disclosure, heat is generally discussed as being taken away from a battery cell or cells. It will be appreciated that the same structure of cooling fins can be used to heat battery cells or other energy storage cells. In such an embodiment, a coolant heating device can be used, for example, to generate heat through electrical resistance or burning of fuel, and heat can be supplied or maintained to an exemplary battery under cold environmental conditions to achieve a desired operating temperature for the energy storage device.

Graphene is a substance that greatly increases thermal conductivity of a cooling fin substrate. Use of a graphene enhanced cooling fin is disclosed. Enhancing a cooling fin with graphene can be performed according to a number of envisioned embodiments. For example, a single layer of graphene can be applied or deposited upon one or both sides of a substrate. Such a substrate can be made of metal, plastic, ceramic material, or any other material known in the art. In another example, layers of graphene can be used upon and between layers of substrate materials. For example, a cooling fin can include layers of aluminum, copper, and/or steel, with layers of graphene deposited between the multiple layers of metal. Two layers of un-enhanced plastic and surround a single layer of graphene enhanced plastic, or two layers of graphene enhanced plastic can surround a single layer of un-enhanced plastic. Layers can be joined or bonded together according to processes known in the art.

In another embodiment, graphene can be mixed with a metal and interspersed within the metal to enhance the metal's properties. Such a composite material can be held together with a binder material. Similarly, graphene can be mixed with plastic material and interspersed within the plastic to enhance the plastic's properties. In another example, a layer or layers of electrical or flame-retardant insulation can be used with the metallic substrate. In another example, expansion-absorbing layers known as gap pads can placed internally or externally to the cooling fin.

While layers of graphene of thicknesses of up to or over 0.5mm are known and contemplated for use with the presently disclosed cooling fins, layers of as little as one molecule thick can be used upon a cooling fin substrate in accordance with the presently disclosed device. Complete layers or complete sheets of graphene material can be used. However, such sheets can be expensive and difficult to produce and maintain in an undamaged state.

Use of graphene platelets is known, where overlapping or contacting segments of graphene flakes or platelets conduct heat similarly to intact sheets of graphene. Throughout the disclosure, graphene enhanced materials can include graphene layers, graphene sheets, or use of graphene platelets.

Known battery cooling fin configurations with sufficient heat transfer capacity to cool battery cells typically include fins utilizing a flow of liquid coolant between the battery cells. Conventional, un-enhanced cooling fins made with a solid panel substrate typically cannot efficiently conduct enough heat away from the battery cells to be effective. Solid-metal or solid plastic fin substrates enhanced with graphene can used to transfer heat away from the source of the heat, such as a battery cell. Cooling tubes or cold plates in thermally conductive contact with the enhanced cooling fin can subsequently remove heat from the cooling fin. The disclosed graphene enhancements greatly increase a capacity of a solid panel substrate to conduct heat.

Further, graphene enhanced cooling fins are useful for applications where a large amount of heat must be removed or transferred to or from a device. However, the structures disclosed herein and illustrated in the figures can be used with simple metallic fins, such as aluminum or molded plastic fins, depending upon the heat transfer requirements of the application. The disclosure is intended to encompass any structure with the disclosed properties.

A fin or cooling plate can be constructed with a plastic material created through an injection molding process with graphene evenly interspersed through the material. In the process of injection molding or otherwise forming the plastic, graphene can be added to the component plastic pellets used to form the housing, such that graphene is interspersed throughout the plastic material. Testing has shown increased thermal conductivity through a plastic housing infused with graphene as opposed to the same plastic material without the graphene.

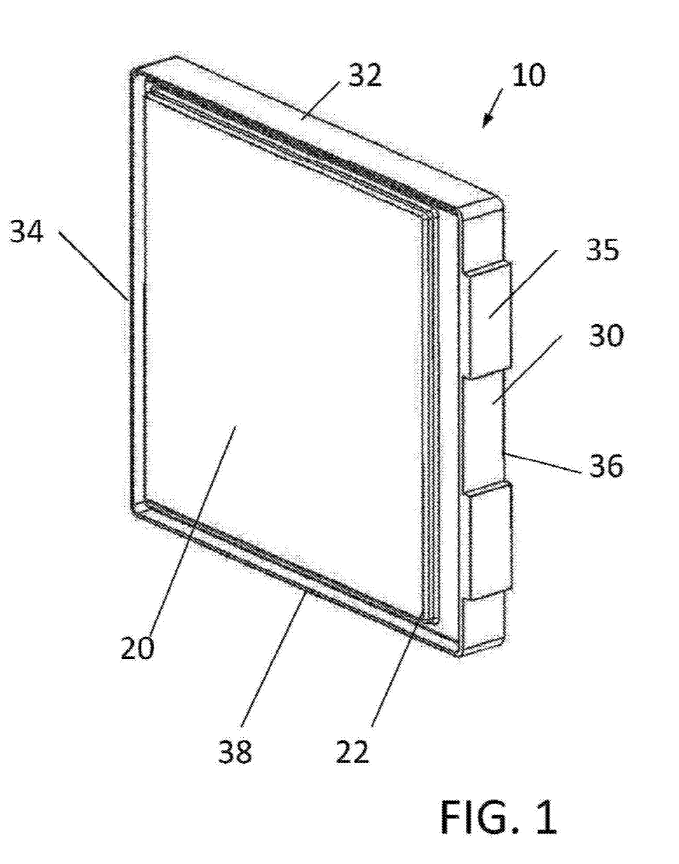

Referring now to the drawings, wherein the showings are for the purpose of illustrating certain exemplary embodiments only and not for the purpose of limiting the same, FIG. 1 illustrates an exemplary graphene enhanced cooling fin for use in a multi-cell battery pack from a top, front perspective view. Graphene enhanced cooling fin 10 is constructed with exemplary graphene enhanced plastic and is illustrated including a flat panel portion 20 and a structural rim portion 30 surrounding flat panel portion 20. Flat panel portion 20 is illustrated with a large surface area configured to be situated in direct contact with a generally rectangle-shaped battery cell on one side of the panel portion or one on each side of the panel portion. Graphene can be coated on one or both sides of the flat panel portion 20.

Flat panel portion 20 can be entirely flat, with a planar panel contacting the structural rim portion 30. In the embodiment of FIG. 1 indentation 22 around a perimeter of flat panel portion 20 provides an indented pocket within which a battery cell configured to fit within the intended pocket can be securely located and help immobile.

Structural rim portion 30 surrounds both flat panel portion 20 and battery cells held next to flat panel portion 20. In this way, structural rim portion 30 protects the delicate battery cells from damage. Further, structural rim portion 30 can be used to provide features through which a plurality of enhanced cooling fins 10 can be stacked and held securely together. For example, structural rim portion 30 of FIG. 1 includes a plurality of protrusions 35 extending outwardly from the surface of structural rim portion 30. These protrusions 35 can be gripped by or be used to guide the location of brackets, straps, or other affixing devices useful to retain the plurality of enhanced cooling fins 10 and the battery cells contained therein in place. The non-limiting, exemplary structural rim portion 30 of FIG. 1 includes a generally rectangular perimeter including top surface 32, side surfaces 34 and 36, and bottom surface 38. Walls of structural rim portion 30 are aligned approximately perpendicular to the flat surface of flat panel portion 20.

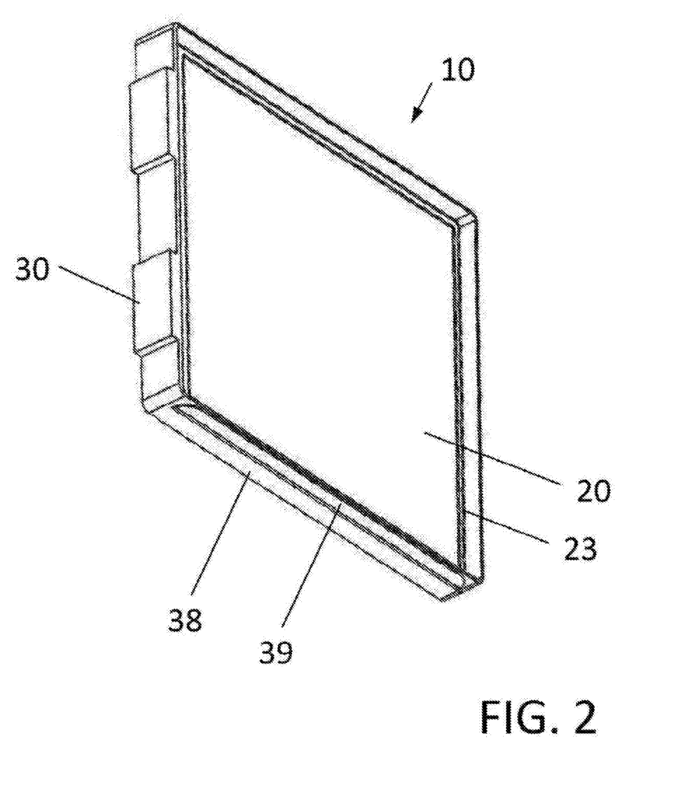

FIG. 2 illustrates the graphene enhanced cooling fin of FIG. 1 from a bottom, rear perspective view. Graphene enhanced cooling fin 10 is illustrated including flat panel portion 20 and structural rim portion 30. Flat panel portion 20 is substantially of uniform thickness across the flat planar surface. Indentation 23 is shown as an inverse of indentation 22 of FIG. 1. Bottom surface 38 is illustrated with an optional lip 39 configured to aid in securing graphene enhanced cooling fin 10 to a plate later to be assembled below the cooling fin.

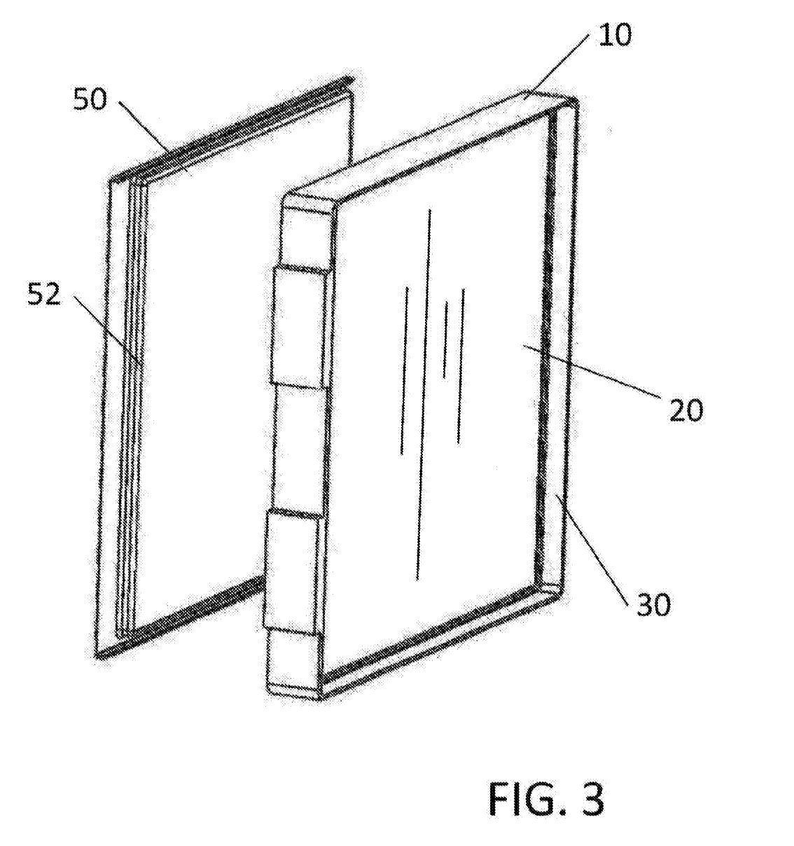

FIG. 3 illustrates an exemplary battery cell aligned for assembly with the enhanced cooling fin of FIG. 1. Graphene enhanced cooling fin 10 is illustrated including flat panel portion 20 and structural rim portion 30. Battery cell 50 is illustrated including contour 52 configured to enable battery cell 50 to align fittingly to the contours of the indented pocket of flat panel portion 20. It will be appreciated that battery cell 50 can include electrical connections of various shapes and sizes configured to connect the cell to other battery cells and to the electrical subsystems of the vehicle or system being powered. Enhanced cooling fin 10 can include cut-outs, indentations, and or electrical fittings not illustrated to facilitate the necessary electrical connections of battery cell 50.

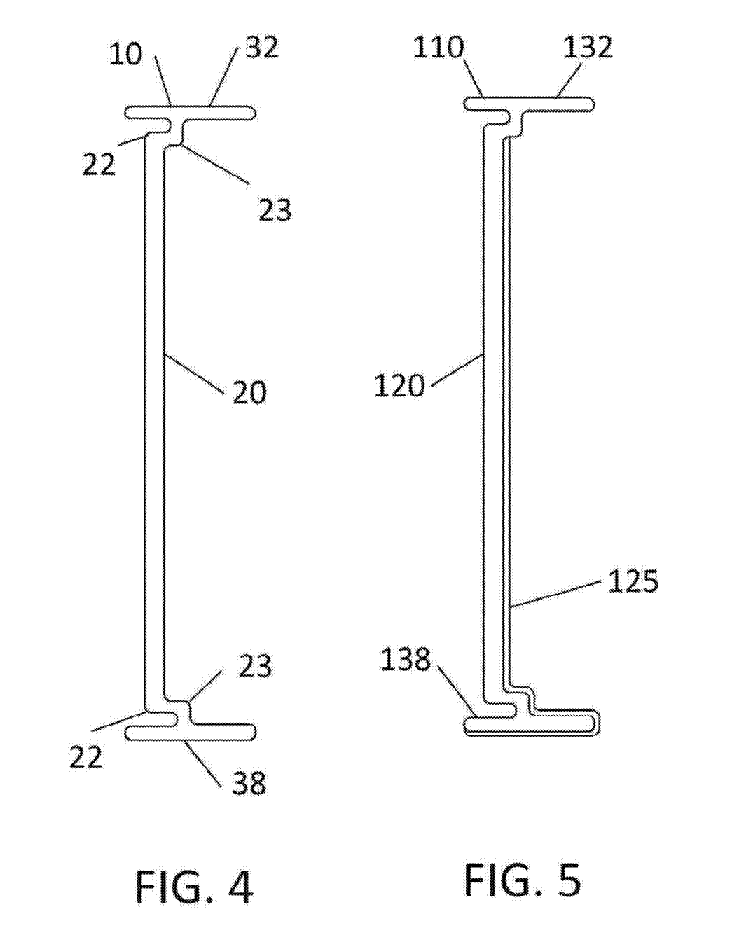

FIG. 4 illustrates an exemplary cross sectional view of the enhanced cooling fin of FIG. 1. Graphene enhanced cooling fin 10 is illustrated including flat panel portion 20, top surface 32 of the structural rim portion, and bottom surface 38 of the structural rim portion. Indentations 22 and 23 are illustrated where the flat panel portion 20 intersects both top surface 32 and bottom surface 38, resulting in the indented pocket shape of flat panel portion 20. Graphene enhanced cooling fin 10 is illustrated without any visually perceptible graphene layer on any surface of the fin and can be exemplary of a cooling fin enhanced with either an imperceptibly thin layer of graphene platelets on one or all surfaces of the fin or with graphene platelets interspersed within plastic material constructing enhanced cooling fin 10.

FIG. 5 illustrates an exemplary cross sectional view of an alternative embodiment of a graphene enhanced cooling fin with a layer of graphene platelets covering one side of a flat panel portion. Graphene enhanced cooling fin 110 is illustrated including flat panel portion 120, top surface 132 of the structural rim portion, and bottom surface 138 of the structural rim portion. A thin but perceptible layer 125 of graphene is illustrated on one side of flat panel portion 120 and projecting contiguously to a bottom side of bottom surface 138. Layer 125 can be any thickness. The illustration of layer 125 is provided in exaggerated as compared to an exemplary layer thickness of 0.5 mm for purposes of illustration. In another embodiment, layer 125 could be illustrated on the other side of flat panel portion 120 or on both sides of flat panel portion 120. Layer 125 running contiguously from flat panel portion 120 to the bottom side of bottom surface 138 provides a low-resistance path for heat to travel along layer 125, transmitting heat from a battery cell neighboring flat panel portion 120 to a cooling plate or other similar structure neighboring the bottom side of bottom surface 138.

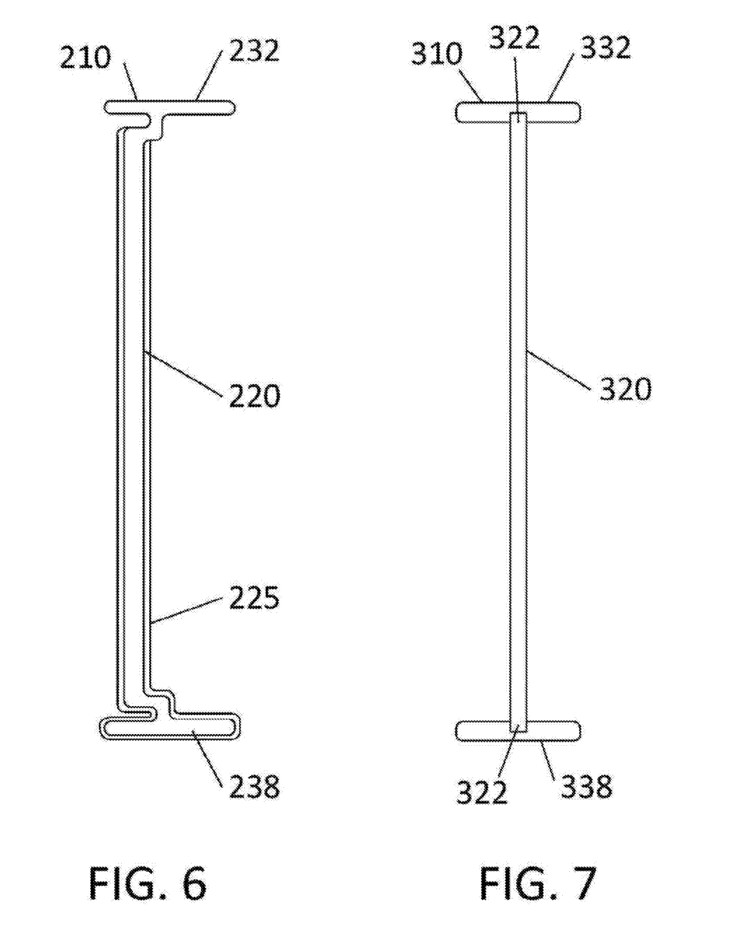

FIG. 6 illustrates an exemplary cross sectional view of an alternative embodiment of a graphene enhanced cooling fin with a layer of graphene platelets covering both sides of a flat panel portion. Graphene enhanced cooling fin 210 is illustrated including flat panel portion 220, top surface 232 of the structural rim portion, and bottom surface 238 of the structural rim portion. Enhanced cooling fin 210 is similar to enhanced cooling fin 110 except that a thin but perceptible layer 225 of graphene is illustrated on both sides of flat panel portion 225 and projecting contiguously to a bottom side of bottom surface 238. Enhanced cooling fin 210 can efficiently transfer heat away from two battery cells, one on either side of flat panel portion 220.

FIG. 7 illustrates an exemplary cross sectional view of an alternative embodiment of a graphene enhanced cooling fin with an exemplary enhanced aluminum plate surrounded around a perimeter by an enhanced plastic structural rim portion. Graphene enhanced cooling fin 310 is illustrated including planar flat panel portion 320, top surface 332 of the structural rim portion, and bottom surface 338 of the structural rim portion. Some embodiments of cooling fins include indented pockets formed upon flat panel portions of the fins. The exemplary embodiment of FIG. 7 includes a planar flat panel portion 320 not including an indented pocket. Planar flat panel portion 320 includes an exemplary graphene enhanced aluminum plate configured to transfer heat away from a neighboring battery cell or cells. A perimeter 322 of flat panel portion 320 is captured or molded within an enhanced plastic structural rim portion including top surface 332 and bottom surface 338. Perimeter 322 can optionally include grooves or other features configured to enhance the physical connection between flat panel portion 320 and the structural rim portion.

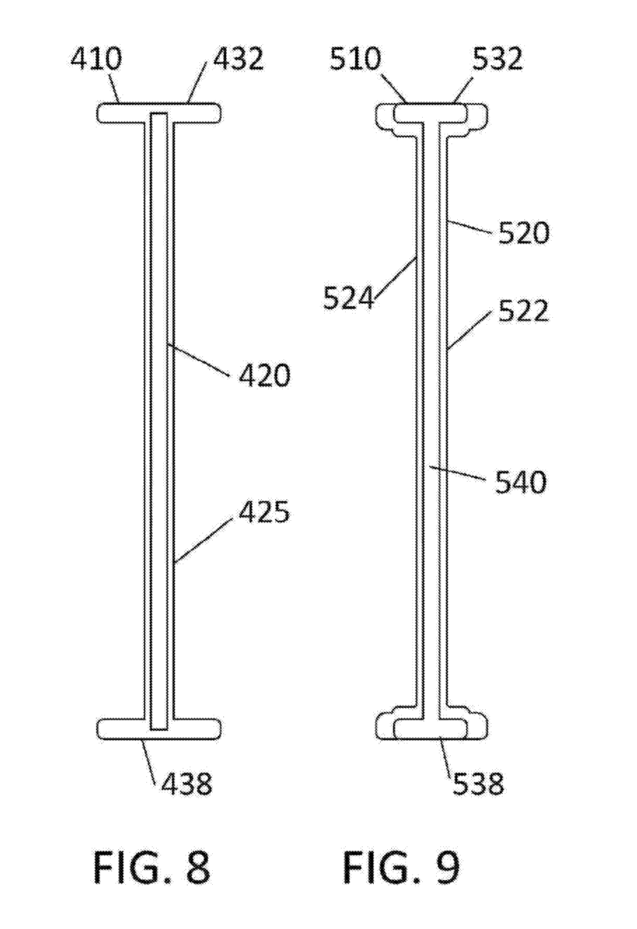

FIG. 8 illustrates an exemplary cross sectional view of an alternative embodiment of a graphene enhanced cooling fin with an exemplary aluminum plate surrounded entirely by an enhanced plastic structural rim portion. Graphene enhanced cooling fin 410 is illustrated including planar flat panel portion 420, top surface 432 of the structural rim portion, and bottom surface 438 of the structural rim portion. Planar flat panel portion 420 can optionally be enhanced with graphene. A layer of graphene enhanced plastic 425 covers both sides of flat panel portion 420. The graphene enhanced material of layers 425 can be contiguously formed with graphene enhanced plastic forming top surface 432 and bottom surface 438 of a structural rim portion. In one embodiment, for manufacturing reasons, small holes can be formed in layers 425 to enable the flat panel portion 420 to be held in place while the plastic material is injection molded around flat panel portion 420.

FIG. 9 illustrates an exemplary cross sectional view of an alternative embodiment of a graphene enhanced cooling fin with an exemplary central plate sandwiched on either side entirely by enhanced plastic surface portions. Graphene enhanced cooling fin 510 is illustrated including planar flat panel portion 520, top surface 532 of the structural rim portion, and bottom surface 538 of the structural rim portion. Cooling fin 510 includes a central plate 540 sandwiched between a first enhanced plastic surface portion 522 and a second enhanced plastic surface portion 524. Battery cells positioned between cooling fins, depending upon the particular configuration of the battery cells, can require that a non-electrically conductive insulator be positioned between the battery cells. Central plate 540 can include a nonconductive material, such as a plastic or other polymer or a ceramic material not enhanced with graphene. First enhanced plastic surface portion 522 and second enhanced plastic surface portion 524 can each transmit heat away from neighboring battery cells, but because first enhanced plastic surface portion 522 and second enhanced plastic surface portion 524 are separated by the nonconductive central plate 540, the two neighboring battery cells are electrically isolated from each other.

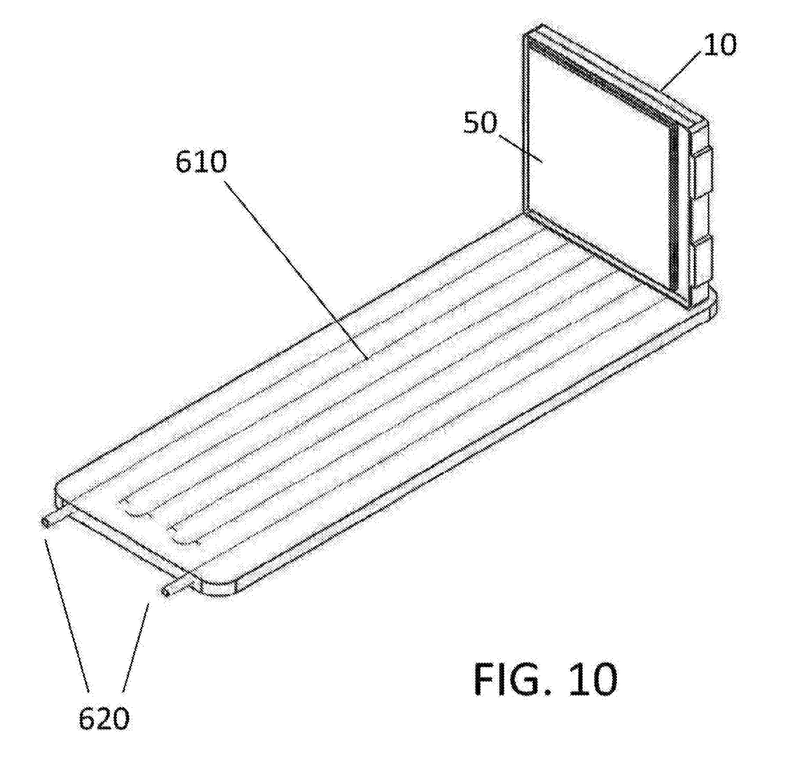

FIG. 10 illustrates the graphene enhanced cooling fin of FIG. 1 with a battery cell engaged thereto, with the enhanced cooling fin installed to an exemplary liquid cooled cooling plate. Graphene enhanced cooling fin 10 is illustrated with battery cell 50 engaged thereto. Cooling plate 610 is illustrated with liquid cooling lines 620 provided, where a liquid coolant can be forced through cooling lines 620 to remove heat from cooling plate 610. Cooling plate 610 can include graphene enhanced material. In some embodiments, cooling plate 610 may not need to be liquid cooled.

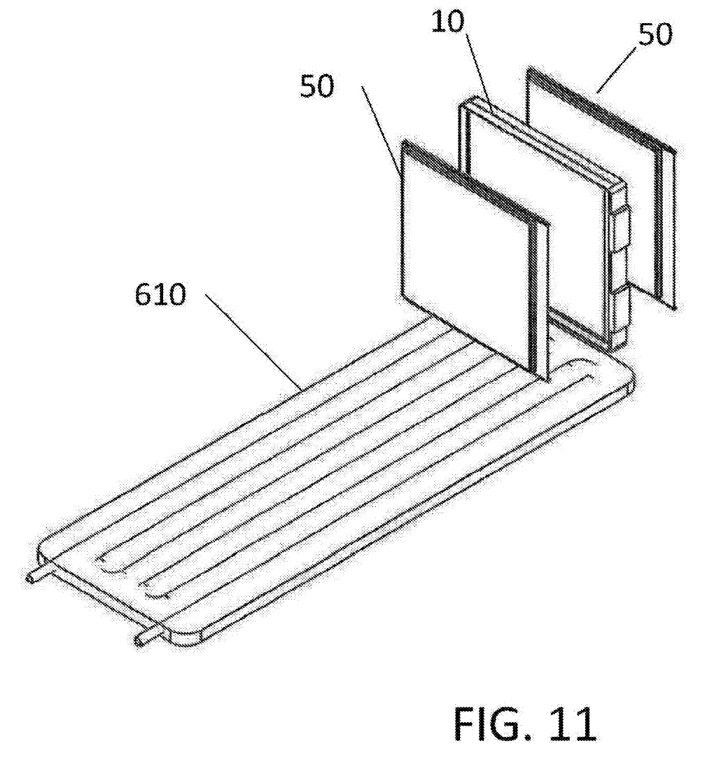

FIG. 11 illustrates the graphene enhanced cooling fin of FIG. 10 separated from the cooling plate for illustration, with two battery cells positioned to be engaged to either side of the enhanced cooling fin. Enhanced cooling fin 10 is illustrated, including two battery cells 50 illustrated in a position in preparation to be engaged to either side of enhanced cooling fin 10. Enhanced cooling fin 10 can be attached to cooling plate 610 as is illustrated in FIG. 10.

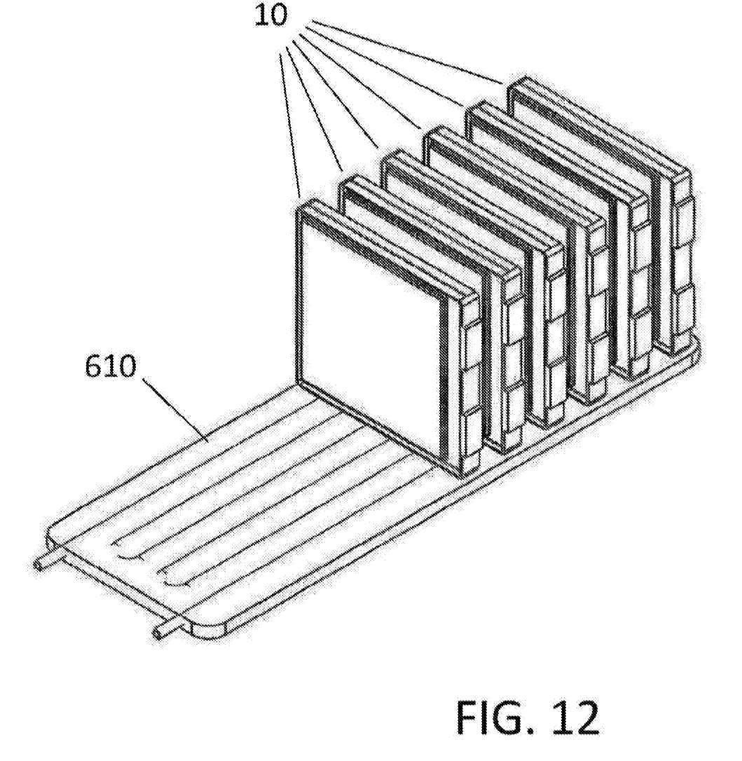

FIG. 12 illustrates a plurality of enhanced cooling fins attached to the cooling plate of FIG. 10. Cooling plate 610 is illustrated, and a plurality of graphene enhanced cooling fins 10 are attached to cooling plate 610. A battery cell can be located between each of the enhanced cooling fins 10.

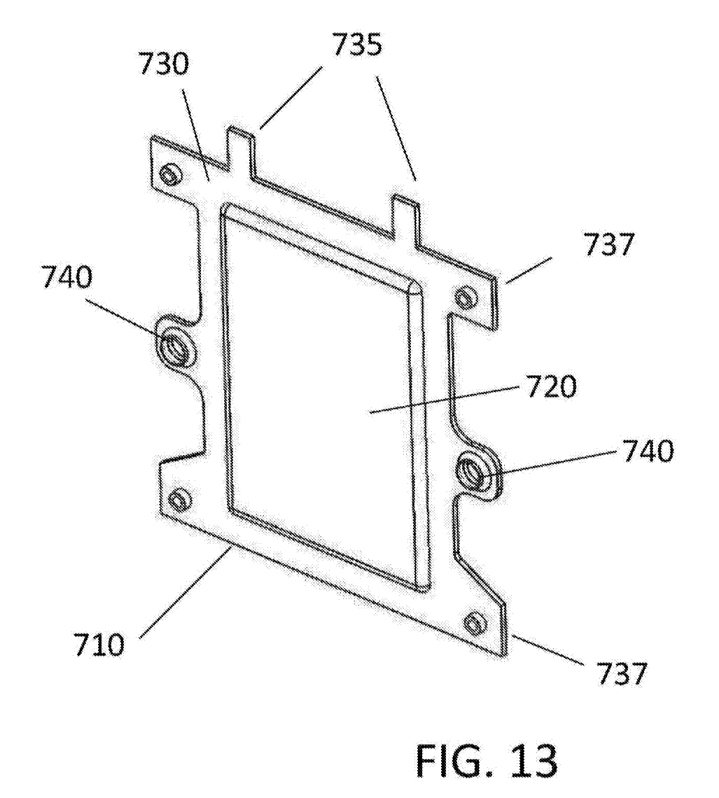

FIGS. 13-16 illustrate an additional embodiment of battery cell components that are made with plastic enhanced with graphene. FIG. 13 illustrates a plastic housing enhanced with graphene configured to transfer heat away from a battery core. Graphene enhanced cooling fin 710 is illustrated including flat panel portion 720 and structural rim portion 730. Flat panel portion 720 includes an optional indented pocket configured to securely locate a battery cell between the enhanced cooling fin and a second enhanced cooling fin. Structural rim portion 730 includes structural tabs 737 including holes configured to accept fasteners or pins to hold enhanced cooling fin 710 in place and structural tabs 735 for some other purpose such as securing the enhanced cooling fin 710 to some other structure or device. Structural rim portion 730 is similar to structural rim portion 30 of FIG. 1, except that surfaces of structural rim portion 730 are generally parallel to flat panel portion 720. Coolant line brackets 740 are provided, such that a liquid filled coolant line can be inserted within coolant line brackets 740 for the purpose of transmitting heat away from enhanced cooling fin 710. By enhancing enhanced cooling fin 710 to promote a rate of heat transfer from flat panel portion 720 to coolant line brackets 740, performance of enhanced cooling fin 710 can be improved.

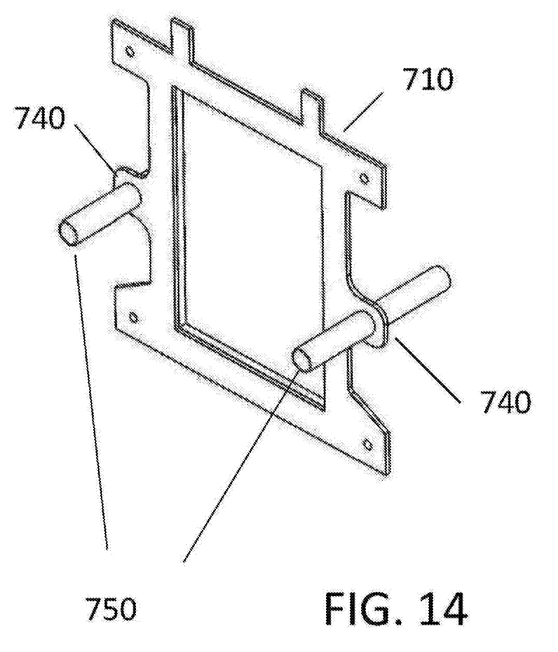

FIG. 14 illustrates coolant lines that can be installed to the enhanced cooling fin of FIG. 13 in order to transfer heat away from the enhanced cooling fin. Enhanced cooling fin 710 if FIG. 13 is illustrated, with coolant lines 750 installed to coolant line brackets 740.

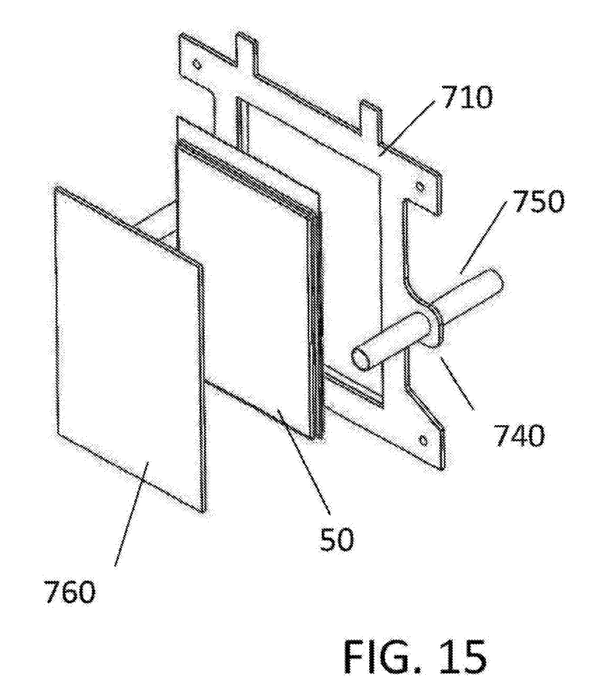

FIG. 15 illustrates the enhanced cooling fin and coolant lines of FIG. 14, with a battery core and a cover in an expanded view, with the core in position to be placed within an indented pocket in the enhanced cooling fin.

Enhanced cooling fin 710 of FIG. 13 is illustrated, with coolant lines 750 installed to coolant line brackets 740. Battery cell 50 is illustrate positioned in preparation for being engaged to an indented pocket formed in the face of enhanced cooling fin 710. A plastic cover 760 is illustrated positioned in preparation for being applied over battery cell 50 once it is engaged to enhanced cooling fin 710. Plastic cover 760 may be enhanced with graphene and can seal or encapsulate battery cell 50 against enhanced cooling fin 710.

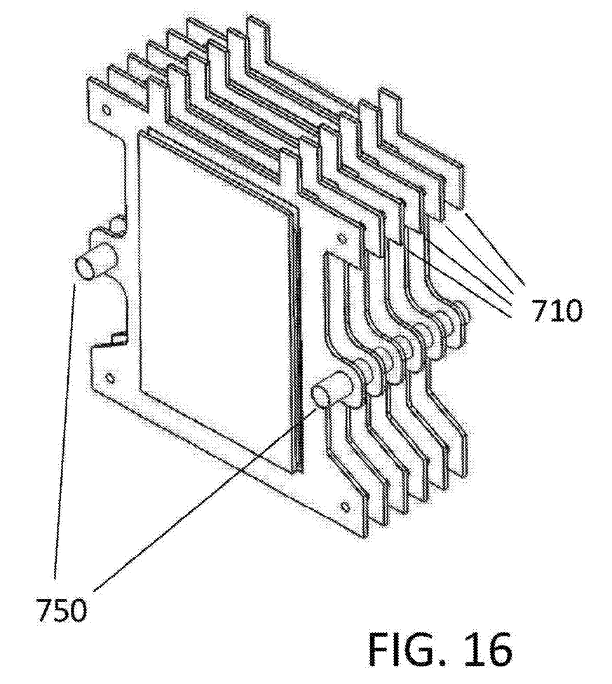

FIG. 16 illustrates a plurality of enhanced cooling fins with battery cores installed thereto stacked and attached to coolant lines. A plurality of enhanced cooling fins 710 are illustrated stacked against each other, with battery cells contained therebetween and/or therewithin, with coolant lines 750 attached to the enhanced cooling fins 710. As coolant is forced through coolant lines 750, heat is transferred away from enhanced cooling fins 710.

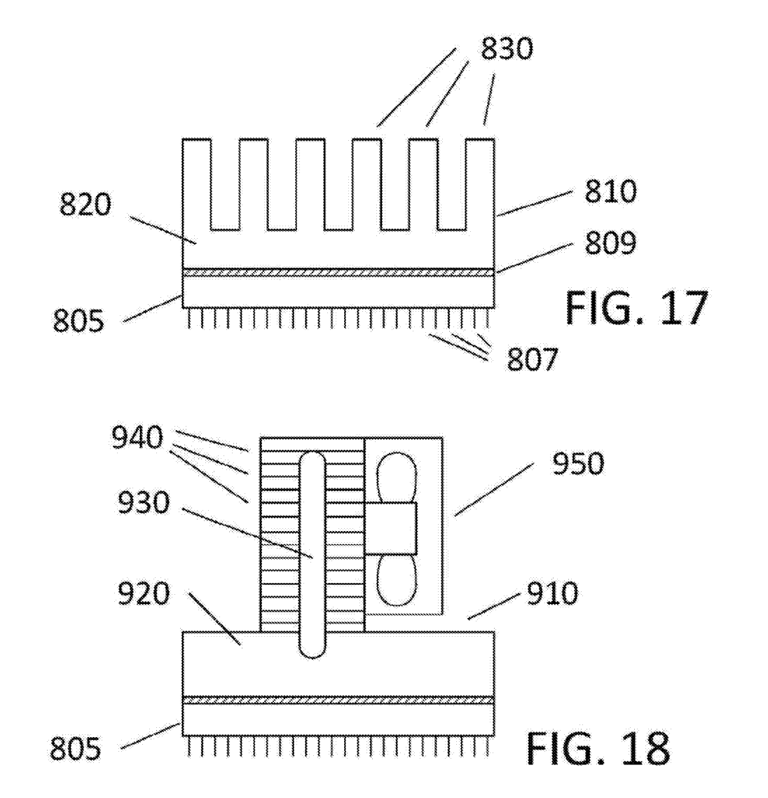

Other types of heat exchangers can benefit from graphene enhanced cooling fins and particularly graphene enhanced plastic cooling fins. FIG. 17 illustrates an exemplary central processing unit cooling fin constructed with a graphene enhanced plastic material. Central processing unit (CPU) chip 805 is illustrated including a plurality of pins 807 configured to connect chip 805 to a computer motherboard. It is known that such CPU chips generate a lot of heat during operation. Graphene enhanced plastic cooling fin 810 is illustrated, connected to CPU chip 805 with silver thermal paste layer 809. Enhanced plastic cooling fin 810 includes base portion 820 configured to span and receive heat from CPU chip 805. Enhanced plastic cooling fin 810 further includes air cooled fins 830 configured to expel heat to air proximate to the fins. Any portion or all of enhanced plastic cooling fin 810 can include graphene layers or graphene interspersed within the fin material to enhance heat transfer properties.

FIG. 18 illustrates an additional exemplary central processing unit cooling fin constructed with a graphene enhanced plastic material and including a phase change circuit. CPU chip 805 is illustrated. Cooling fin assembly 910 is illustrated including base portion 920 configured to span and receive heat from CPU chip 805, stacked air cooled heat transfer fins 940, phase change circuit 930 including a liquid configured to transfer heat from 18 base portion 920 to heat transfer fins 940, and powered fan unit 950 blowing air through heat transfer fins 940. Any or all portions of cooling fin assembly 910 can include graphene layers or graphene interspersed within the fin material to enhance heat transfer properties.

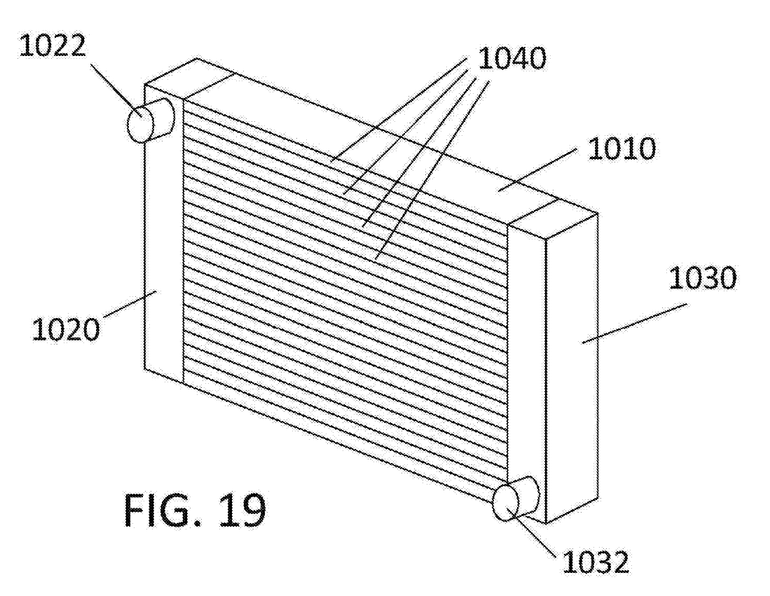

FIG. 19 illustrates an exemplary radiator device used in automotive applications with graphene enhanced plastic cooling structures. Radiator device 1010 is illustrated including a first header 1020, a second header 1030, and a plurality of flattened tubes 1040 connecting the two headers. Liquid is forced in one fluid tube 1022, passes through header 1020, through attached tubes 1040, into header 1030, and out a second fluid tube 1032. As is known in the art, headers can be configured to force the liquid to make multiple passes back and forth through the tubes in order to achieve maximum cooling. As is also known in the art, fins can be formed or sandwiched between tubes 1040 in order to maximize surface area and heat transfer between the liquid within the tubes and air passing through radiator device 1010. such a heat exchanger is typically constructed with aluminum tubes and fins and with plastic headers. Any of the surfaces of the radiator device can be enhanced with graphene to improve heat transfer characteristics. Further, as is achieved in the enhanced cooling fin of FIG. 1, the device of FIG. 19 can be simplified by, for example, only using one header, with a fluid tube at a top and a bottom, with graphene enhanced, air cooled tubes extending outwardly from the header. This would eliminate the weight and leakage failures caused by running tubes 1040 between two headers. In another embodiment, both headers 1020 and 1030 could each include two fluid tubes, each having a fluid flow just through the header, and with air-cooled graphene enhanced fins extending between the headers. FIG. 19 illustrates a fluid to air heat exchanger. Other fluid to air heat exchangers can be similarly improved, such as an air conditioning evaporator core or condenser core. Similarly, a fluid to fluid heat exchanger or an air to air heat exchanger can be similar improved, for example, replacing tubes carrying a flow through the tube with a simple fin attached to a header unit.

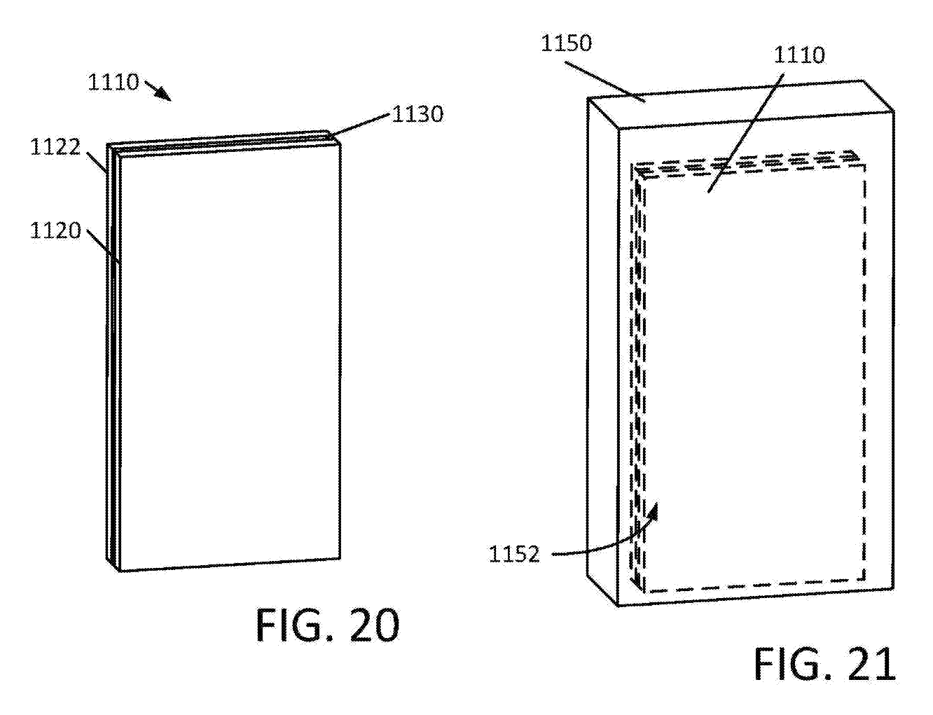

FIG. 20 illustrates an exemplary pair of aluminum plates with a layer of graphene materials interposed between the plates. Enhanced aluminum plate assembly 1110 is illustrated including a first aluminum plate 1120, a second aluminum plate 1122, and a layer of graphene materials 1130 interposed between the aluminum plates. Enhanced aluminum plate assembly 1110 is useful to efficiently distribute heat through and across the layer of graphene materials 1130.

FIG. 21 illustrates the aluminum plates and graphene materials of FIG. 20 encased within a molded plastic unit. Enhanced aluminum plate assembly 1110 of FIG. 20 is illustrated surrounded by plastic materials of molded plastic unit 1150. In one embodiment, in a process known in the art as insert molding, enhanced aluminum plate assembly 1110 can be placed within an injection mold cavity, and plastic material can be injection molded around assembly 1110 to form molded plastic unit 1150. Front surface 1152 of unit 1150 can be configured to receive heat, for example, as from a neighboring battery cell. An edge of enhanced aluminum plate assembly 1110 can be exposed from a side of unit 1150, for example, allowing heat to transferred from enhanced aluminum plate assembly 1110.

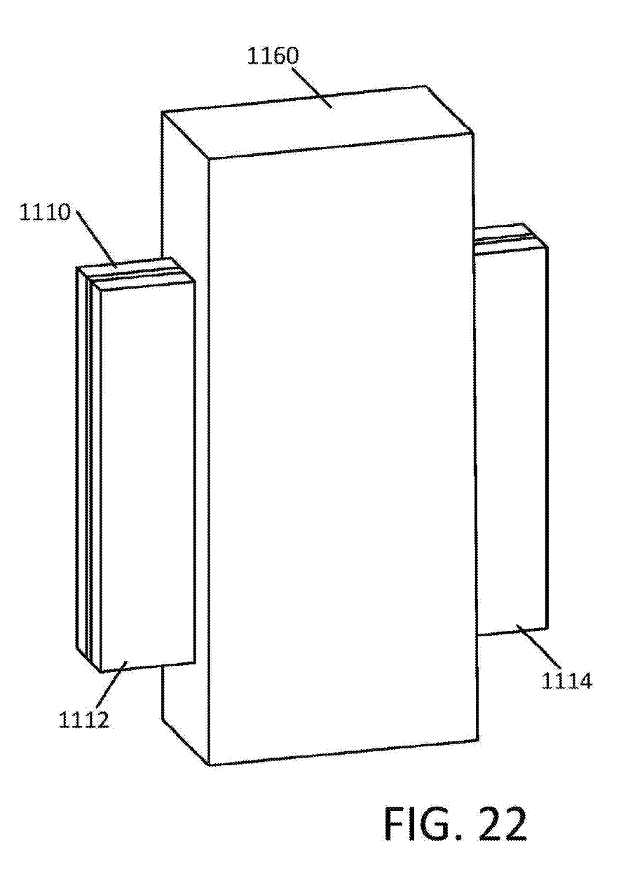

FIG. 22 illustrates the aluminum plates and graphene materials of FIG. 20 partially encased within a molded plastic unit, with heat rejection fins exposed on either side of the aluminum plates. Enhanced aluminum plate assembly 1110 of FIG. 20 is illustrated surrounded by plastic materials of molded plastic unit 1160. In one embodiment, in a process known in the art as insert molding, enhanced aluminum plate assembly 1110 can be placed within an injection mold cavity, and plastic material can be injection molded around assembly 1110 to form molded plastic unit 1160. A first portion 1112 and a second portion 1114 of enhanced aluminum plate assembly 1110 protrude from unit 1160, such that portions 1112 and 1114 are exposed. In one embodiment, portion 1112 and 1114 can act as heat fins, exchanging heat with nearby air or liquid flowing around portions 1112 and 1114. In one embodiment, heat transferred to portion 1112 can flow through enhanced aluminum plate assembly 1110 to portion 1114 and subsequently flow to a gas or liquid proximate to portion 1114.

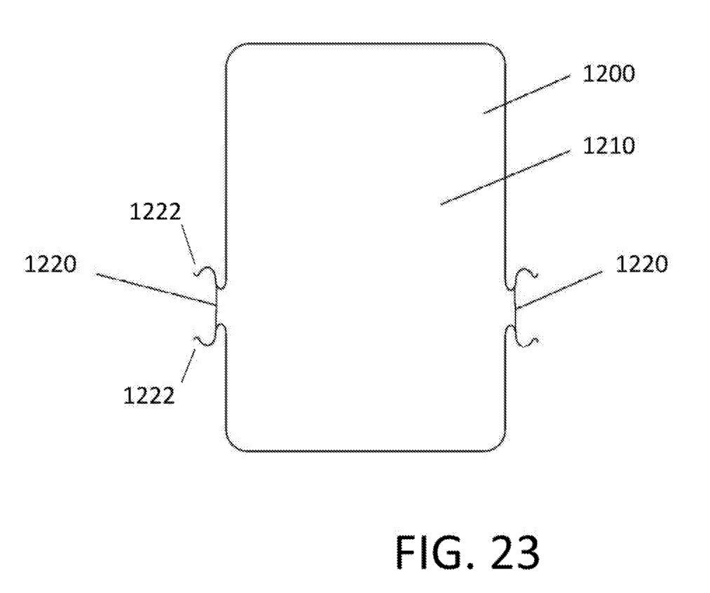

FIG. 23 illustrates an additional exemplary embodiment of an enhanced cooling fin including a pair of snap-fit gripping features configured to engage cooling tubes to the cooling fin. Graphene enhanced cooling fin 1200 is illustrated including a flat planar body portion 1210 and a plurality of cooling tube gripping features 1220. Gripping features 1220 include a pair of arcuate tabs configured to wrap around and snappingly secure a cooling tube. Gripping feature tabs can but need not include lead in arcuate bends 1222 to facilitate snapping of a tube into place. Body portion 1210 is illustrated with a large surface area configured to be situated in direct contact with a generally rectangle-shaped batterycell on one side of the body portion or one on each side of the body portion. Graphene can be coated on one or both sides of the cooling fin. In one embodiment, body portion 1210 and/or gripping features 1220 can include a plurality of layers of structural materials and graphene or graphene enhanced materials. Surfaces of body portion 1210 and/or gripping features 1220 can include aluminum faces or tabs that enable traditional aluminum to aluminum bonding methods such as soldering and brazing to be used to secure parts of the battery system together. As described herein, layers of structural materials can be used in combination with layers of graphene as composite cooling fins, taking advantage of the alternative properties of strength and enhanced heat transfer capabilities. In relation to the embodiment of FIG. 23, gripping features 1220 can include a first structural layer of exemplary aluminum providing structural rigidity and a second layer of graphene materials providing thermal conductivity. In addition, in places where significant wear is likely to experiences upon the part, such as arcuate bends 1222 when a cooling tube is being press fit into features 1220, a third layer of resilient material, such as aluminum plating, a plastic shield, or a sprayed on resin can be used to avoid damage to the layer of graphene. Such a protective layer or feature can cover all of gripping feature 1220. In another embodiment, a portion of gripping feature 1220 such as within the internal curves of the C-shape can leave the graphene layer exposed to enable a direct contact of the graphene layer with the cooling tube to be installed.

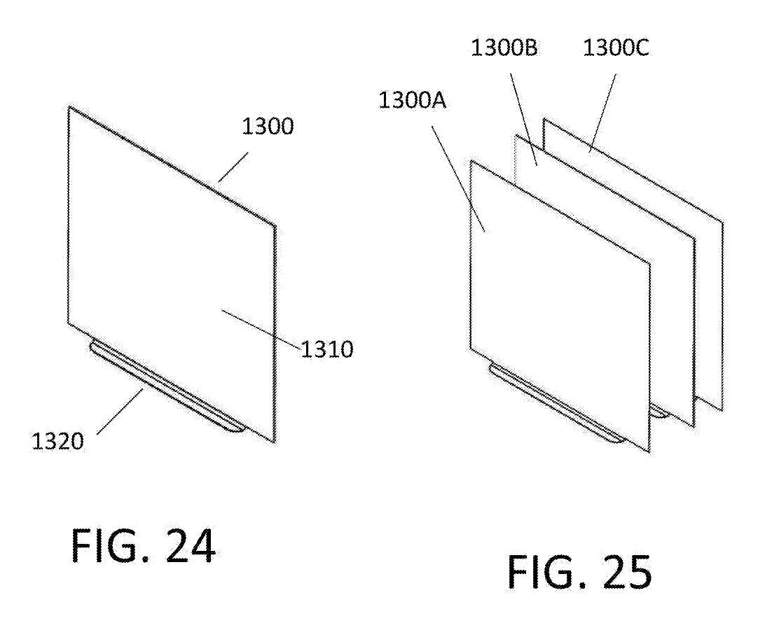

FIG. 24 illustrates an additional exemplary embodiment of an enhanced cooling fin including a ninety degree bend for attachment to a cooling plate. Graphene enhanced cooling fin 1300 is illustrated including a flat planar body portion 1310 and ninety degree bend resulting in a perpendicular tab 1320. Body portion 1310 is illustrated with a large surface area configured to be situated in direct contact with a generally rectangle-shaped batterycell on one side of the body portion or one on each side of the body portion. Graphene can be coated on one or both sides of the cooling fin. Perpendicular tab 1320 is configured to be connected to or placed in proximate contact with a cooling plate. In one embodiment, body portion 1310 and/or perpendicular tab 1320 can include a plurality of layers of structural materials and graphene or graphene enhanced materials.

FIG. 25 illustrates a stack of a plurality of cooling fins according to the cooling fin of FIG. 24. Graphene enhanced cooling fins 1300A, 1300B, and 1300C are similar or identical to cooling fin 1300 of FIG. 24 and are illustrated with their body portions aligned in parallel, such that there is a space between each body portion. A battery cell can be fitted with each of the spaces between the body portions of cooling fins 1300A, 1300B, and 1300C. The perpendicular tabs of cooling fins 1300A, 1300B, and 1300C are aligned with each other such that a planar cooling plate can be placed up against the perpendicular tabs and exchange heat therewith.

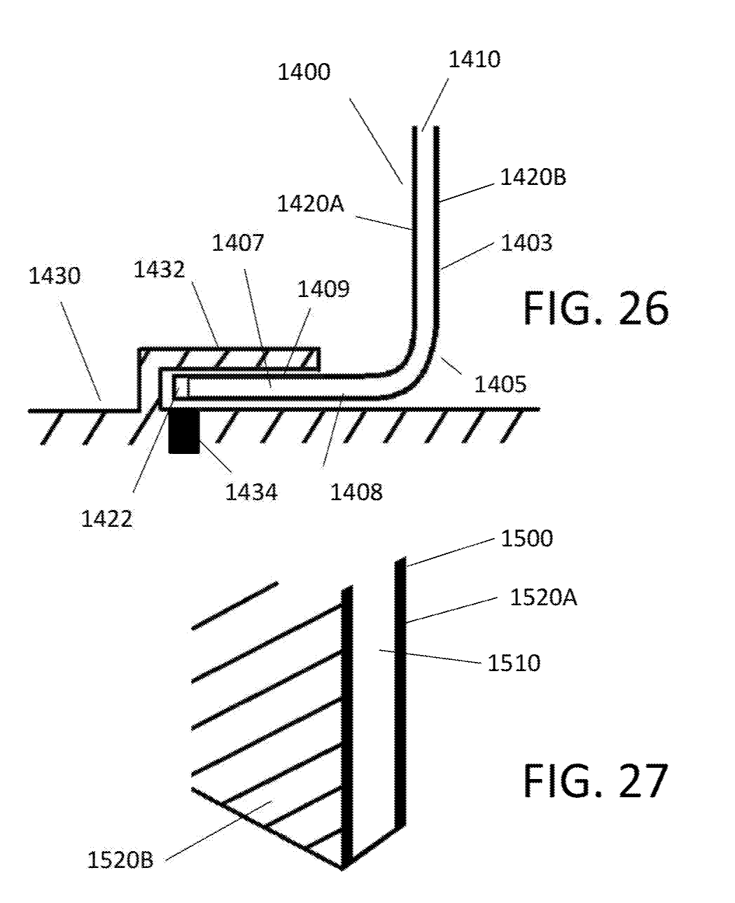

FIG. 26 illustrates an exemplary multi-layered cooling fin including a structurally rigid core material coated on both sides with graphene material including a ninety degree bend in the cooling fin. Graphene enhanced cooling fin 1400 is illustrated including a flat body portion 1403, a ninety degree bend portion 1405, and a perpendicular tab 1407 oriented perpendicularly to flat body portion 1403. Cooling fin 1400 includes an structurally rigid core material 1410, including exemplary aluminum, steel, plastic, or similar material providing physical strength to the cooling fin. Cooling fin 1400 further includes layer 1420A of graphene material on a first side of the cooling fin and layer 1420B of graphene material on a second side of the cooling fin. Both layers of graphene material can run from flat body portion 1403, across ninety degree bend portion 1405, and along perpendicular tab 107 to transmit heat along the graphene material layers.

An exemplary cooling plate 1430 is illustrated which optionally can be coated or treated with graphene materials. Heat can be transferred from a bottom face 1408 of perpendicular tab 1407 into cooling plate 1430. Heat can be transmitted from layer 1420A to bottom face 1408 by inclusion of optional graphene coating 1422 on an end surface of perpendicular tab 1407. Optional graphene coating 1422 can be described as a graphene section thermally conductively connecting the two graphene material layers. It will be appreciated that optional graphene coating 1422 is exemplary, and other similar structural features can be used to physically connect with a graphene enhanced material layer 1420A to layer 1420B to permit heat to be transferred there between and enable heat transfer to a common surface on cooling plate 1430.

In some embodiments, the battery cells connected to layers 1420A and 1420B can require that the battery cells be electrically insulated from each other. In such instances, structurally rigid core material 1410 can be made of an electrically insulating material, optional graphene coating 1422 can be omitted, and cooling plate 1430 can include conducting bracket 1432 connecting with layer 1420A and an insulating block 1434 preventing electrical conduction between bracket 1432 and a portion of cooling plate 1430 contacting layer 1420B. The configuration of FIG. 26 is exemplary, other configurations can be used to connect a graphene enhanced fin to a cooling plate or other cooling device, and the disclosure is not intended to be limited to the particular exemplary embodiments provided herein.

In the embodiment of FIG. 26, graphene is exposed directly to objects located proximately to cooling fin 1400. It will be appreciated that such an embodiment can be useful to provide maximum cooling to the objects.

FIG. 27 illustrates another exemplary multi-layered cooling fin including a structurally rigid core material coated on both sides with graphene material. Cooling fin 1500 is illustrated including a structurally rigid core material 1510, layer 1520A of graphene material on a first side of cooling fin 1500, and layer 1520B of graphene material on a second side of cooling fin 1500.

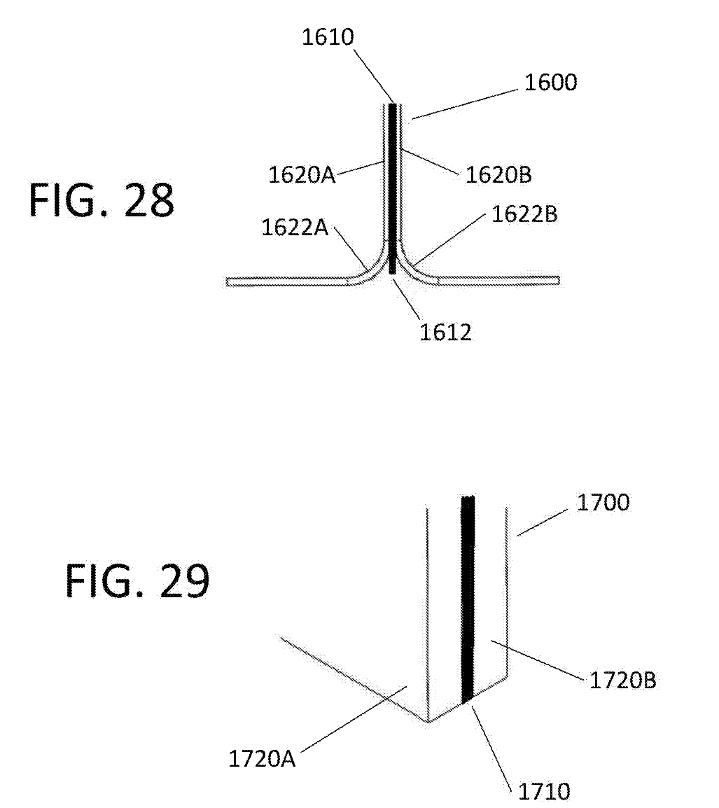

FIG. 28 illustrates an exemplary multi-layered cooling fin including a layer of graphene positioned between two structurally rigid material layers including a ninety degree bends in the structurally rigid material layers. Cooling fin 1600 is illustrated including a first structurally rigid material layer 1620A, a second structurally rigid material layer 1620B, and a layer of graphene material layer 1610 located between the structurally rigid layers. Structurally rigid material layers 1620A and 1620B can include any material such as aluminum, steel, copper, plastic, or other similar materials capable of providing physical strength to the part. If plastic is used, it can be infused with graphene particles to enhance the thermal conductivity of the structurally rigid layer, enhancing heat being transferred from the neighboring battery cell to graphene material layer 1610. Structurally rigid material layers 1620A and 1620B include ninety degree bends 1622A and 1622B, respectively, resulting in perpendicular tab portions extending from each of the structurally rigid material layers. The perpendicular tab portions can include graphene layers extending from layer 1610. In the illustrated embodiment of FIG. 28, layer 1610 includes a graphene material extension 1612 which is configured to connect with some cooling feature proximate to the perpendicular tab portions. The two ninety degree bends and the associated perpendicular tab portions are useful in that the tab portions provide increased surface area for attachment to a proximate cooling plate or similar feature. Such increased surface area can increase structural strength of the part, for example, increase the surface area between the parts to be brazed together. It can additionally increase heat transfer between the parts. In another embodiment, cooling fin 1600 can be used in a air cooled heat exchanger, where the perpendicular tab portions are heat exchange fins, and the added surface area increases the overall heat transfer efficiency of the fins. It should be appreciated that the ninety degree bends described in the figures are exemplary, and any of the ninety degree bends can be substituted with bends or arcuate portions of various angles and dimensions. In one example, the two perpendicular tab portions of FIG. 28 can be replaced with two tabs bent at forty five or one hundred and thirty five degree bends from the body of cooling fin 1600. Tab or fin geometries are provided as non-limiting examples, and the disclosure is not intended to be limited to the particular examples provided herein.

In the embodiment of FIG. 28, one can see that the graphene material layer 1610 is protected on either side by the structurally rigid material layers. Such a configuration can be useful in situations where the outer surface of the cooling fin is subject to abrasion, impact, heat gradients, acidic or caustic substances, or other environmental hazards that might quickly degrade the graphene material.

FIG. 29 illustrates another exemplary multi-layered cooling fin including a layer of graphene positioned between two structurally rigid material layers. Cooling fin 1700 is illustrated including a first structurally rigid material layer 1720A, a second structurally rigid material layer 1720B, and a layer of graphene material layer 1710 located between the structurally rigid layers.

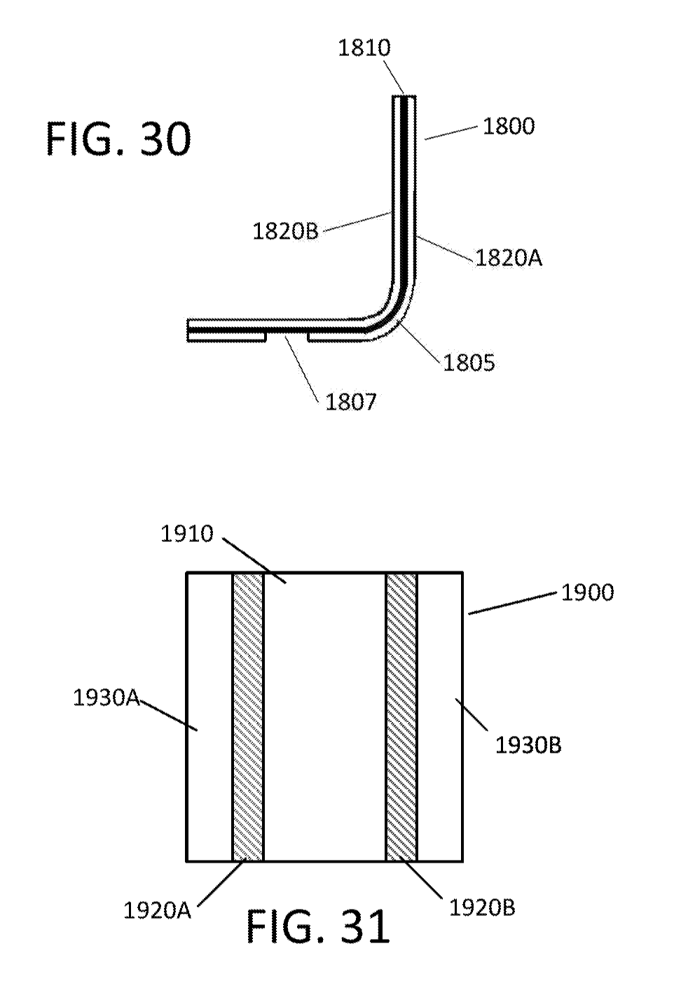

FIG. 30 illustrates another exemplary multi-layered cooling fin including a layer of graphene positioned between two structurally rigid material layers including a ninety degree bend in the cooling fin. Cooling fin 1800 is illustrated including a first structurally rigid material layer 1820A, a second structurally rigid material layer 1820B, and a layer of graphene material layer 1810 located between the structurally rigid layers. Cooling fin 1800 is illustrated including a ninety degree bend 1805, with the structurally rigid material layers and the graphene material layer continuing around bend 1805. An optional window 1807 is illustrated in structurally rigid material layer 1820A, permitting the graphene material layer 1810 to directly contact a cooling feature of a neighboring cooling plate or similar structure.

FIG. 31 illustrates a section of an exemplary multi-layered cooling fin including including a structurally rigid core material coated on both sides with graphene material and with layers of protective material covering the graphene coatings. Graphene enhanced cooling fin 1900 is illustrated including a structurally rigid core material 1910, including exemplary aluminum, steel, plastic, or similar material providing physical strength to the cooling fin. Cooling fin 1900 further includes layer 1920A of graphene material on a first side of the cooling fin and layer 1920B of graphene material on a second side of the cooling fin. Cooling fin 1900 further includes protective material layer 1930A covering layer 1920A and protective material layer 1930B covering layer 1920B. In one embodiment, structurally rigid core material 1910 can include a rigid substrate including aluminum, steel, plastic, or other material configured to provide physical strength to the cooling fin. Graphene material layers 1920A and 1920B coat structurally rigid core material 1910 and provide thermal conductivity. Protective material layers 1930A and 1930B can include aluminum, plastic or other material configured to cover and protect the graphene material layers. In some embodiments, the materials of protective material layers 1930A and 1930B can be treated with graphene to improve thermal conductivity. In one embodiment, protective material layers 1930A and 1930B can be constructed with a graphene treated resin layer primarily configured to protect graphene material layers 1920A and 1920B but also including graphene enhanced heat transfer to the graphene material layers. In one embodiment, the protective material layers can coat one graphene material layer and leave exposed the second graphene material layer.

Heat resistance across battery cells is an issue of concern in the industry. As one battery cell heats up, that heat should not be transmitted to a neighboring battery cell. In some embodiments, a layer of thermally resistant material can be placed between layers of materials on a cooling fin or between two side by side cooling fins. In FIG. 31, structurally rigid core material 1910 can be constructed with a thermally resistant or flame resistant material. In one exemplary embodiment, a polymer such as Nomex® can be used, coated, or infused within structurally rigid core material 1910 to increase thermal resistance, thereby preventing significant heat from being transferred from one battery cell to the next. Similarly, in FIG. 27, a fiberglass or ceramic material, both being thermally resistive materials, can be used for structurally rigid core material 1510.

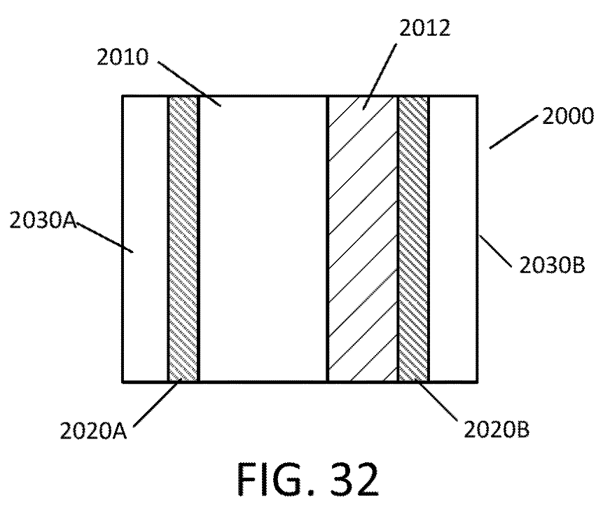

FIG. 32 illustrates a section of an exemplary multi-layered cooling fin including including a structurally rigid core material, graphene material layers, a thermally resistant layer, and with layers of protective material covering the graphene coatings. Graphene enhanced cooling fin 2000 is illustrated including a structurally rigid core material 2010, including exemplary aluminum, steel, plastic, or similar material providing physical strength to the cooling fin. Cooling fin 2000 further includes layer 2012 of thermally resistant material. Cooling fin 2000 further includes layer 2020A of graphene material on a first side of the cooling fin and layer 2020B of graphene material on a second side of the cooling fin. Cooling fin 2000 further includes protective material layer 2030A covering layer 2020A and protective material layer 2030B covering layer 2020B.

FIGS. 23-31 can collectively be described to illustrate various embodiments of a multi-layered graphene enhanced cooling fin. This multi-layered graphene enhanced cooling fin can include a first layer comprising a structurally rigid material layer configured to provide physical strength to the graphene enhanced cooling fin, a second layer comprising a graphene material layer coating a portion a first side of the structurally rigid material layer, and a third layer comprising one of a second structurally rigid material layer covering the graphene material layer and a second graphene material layer coating a portion of a second side of the structurally rigid material layer.

The disclosure has described certain preferred embodiments and modifications of those embodiments. Further modifications and alterations may occur to others upon reading and understanding the specification. Therefore, it is intended that the disclosure not be limited to the particular embodiment(s) disclosed as the best mode contemplated for carrying out this disclosure, but that the disclosure will include all embodiments falling within the scope of the appended claims.

1. An apparatus for cooling a multi-cell energy storage device, the apparatus comprising:
a multi-layered graphene enhanced cooling fin, comprising:
a first layer comprising a structurally rigid material layer configured to provide physical strength to the graphene enhanced cooling fin;
a second layer comprising a graphene material layer coating a portion of a first side of the structurally rigid material layer; and
a third layer comprising one of a second structurally rigid material layer covering the graphene material layer and a second graphene material layer coating a portion of a second side of the structurally rigid material layer.

2. The apparatus of claim 1, wherein the multi-layered graphene enhanced cooling fin further comprises a layer of thermally resistant material.

3. The apparatus of claim 1, wherein the first layer comprising the structurally rigid material layer comprises a layer of thermally resistant material.

4. The apparatus of claim 1, wherein the third layer comprises the second graphene material layer; and
wherein the first graphene material layer and the second graphene material layer are thermally conductively connected with a section of graphene.

5. The apparatus of claim 1, wherein the third layer comprises the second graphene material layer;
wherein the first layer comprising the structurally rigid material layer comprises a layer of electrically insulating material; and
wherein the first graphene material layer and the second graphene material layer are separated from each other by the first layer.

6. The apparatus of claim 1, wherein the third layer comprises the second structurally rigid material layer;
wherein the first structurally rigid material layer comprises a 90 degree bend in a first direction away from second structurally rigid material layer; and
wherein the second structurally rigid material layer comprises a 90 degree bend in a second direction opposite from the first direction away from first structurally rigid material layer.

7. The apparatus of claim 6, wherein the graphene material layer comprises a graphene material extension extending outwardly from the multi-layered graphene enhanced cooling fin.

8. The apparatus of claim 1, wherein a multi-layered graphene enhanced cooling fin comprises cooling tube gripping features.

9. The apparatus of claim 8, wherein the third layer comprises the second structurally rigid material layer covering the graphene material layer over a portion of the cooling tube gripping features.

10. An apparatus for cooling a multi-cell energy storage device, the apparatus comprising:
a multi-layered graphene enhanced cooling fin, comprising:
a first structurally rigid material layer configured to provide physical strength to the graphene enhanced cooling fin;
a second structurally rigid material layer configured to provide physical strength to the graphene enhanced cooling fin; and
a graphene material layer located between the first structurally rigid material layer and the second structurally rigid material layer.

11. The apparatus of claim 10, further comprising a ninety degree bend and a perpendicular tab portion configured to attach to a cooling plate.

12. The apparatus of claim 10, wherein the first structurally rigid material layer comprises an exposed window enabling connection to the graphene material layer through the exposed window.

13. An apparatus for cooling a multi-cell energy storage device, the apparatus comprising:
a multi-layered graphene enhanced cooling fin, comprising:
a structurally rigid material layer configured to provide physical strength to the graphene enhanced cooling fin;
a first graphene material layer coating a portion of a first side of the structurally rigid material layer; and
a second graphene material layer coating a portion of a second side of the structurally rigid material layer.

14. The apparatus of claim 13, further comprising a protective layer coating the first graphene material layer.

15. The apparatus of claim 14, further comprising a second protective layer coating the second graphene material layer.
